(19) United States
(12) Patent Application Publication
(10) Pub. No.: US 2007/0182718 A1
(43) Pub. Date: Aug. 9, 2007

(54) Operator control device

(76) Inventors: Hans-Peter Schoener, Ammertouch (DE); Michael Schreiner, Muehlheim (DE)

Correspondence Address: KENYON & KENYON LLP, ONE BROADWAY, NEW YORK, NY, 10004, US

(21) Appl. No.: 10/558,809

(22) PCT Filed: May 12, 2004
(86) PCT No.: PCT/EP04/05059

§ 371 Date: Dec. 11, 2006

(30) Foreign Application Priority Data
May 30, 2003 (DE) 103 24 579.0

(51) Int. Cl. G06F 3/041

(52) U.S. Cl. 345/173

(57) ABSTRACT

An operator control device for controlling systems in a motor vehicle by inputs by a user includes a touch-sensitive operator control panel on which it is possible to represent two surface shapes which may be changed into one another alternately, with the first surface shape being structured so as to be capable of being sensed in a tactile fashion so that it may be used to select zones on the operator control panel in order to select menu items. The individual selectable zones may be configured differently in shape, extent and their position on the operator control panel, and the second surface shape is smoothed in comparison with the first shape so that hand-written and graphic inputs are possible with it.

### FIELD OF THE INVENTION

The present invention relates to an operator control device in motor vehicles for selecting and operating functions by manual inputs.

### BACKGROUND INFORMATION

In order to avoid confusion, it appears desirable for the increasing variety of systems in motor vehicles, for at least some of the systems and functions such as, for example, car telephones, destination routing system, car radio or air conditioning system, to be operated by a common device. The control of a plurality of systems or functions using a common operator control device is usually carried out by menu-controlled operator surfaces such as are customary and widespread on PCs, palmtops, Internet pages, information systems, automatic travel ticket machines, etc. At each level of the hierarchically organized menus, the operator control alternatives or input alternatives which are respectively available are usually displayed to the user on a display. The user makes a selection from these alternatives by using suitable devices to mark the input alternative which is desired by him and by confirming the selection of this alternative, also using suitable devices, to the controlling system.

German Published Patent Application No. 198 07 410 describes a multi-function operator control device for a motor vehicle for selecting and controlling functions. The individual operator control elements are arranged around a screen. In this context, function pushbutton keys are partially provided with a permanently assigned functionality for safety-related functions and with operator control elements which are realized by switches or knobs. Furthermore, there are further pushbutton keys with a freely programmable functionality. That is to say, the pushbutton keys can support different functions in different operator control situations, essentially as a function of the system to be operated at a particular time, with respective assignment of the pushbutton keys being made by a system for controlling the operator control sequences. In addition, it is possible to use areas of the touch-sensitive screen for directly selecting an input alternative (referred to as Soft-Keys) which has been selected by the user.

For the driver of a vehicle, it is important in every operator control process that his eyes are not distracted from the road over a relatively long period of time. For this reason, it is favorable if operator control facilities are arranged as far as possible in the direct field of vision and the actual operator control device is arranged as far as possible in the directly accessible operator control area. Such an ergonomically advantageous arrangement of display and operator control device, which also provides a menu-controlled operator prompt, is described, for example, in German Published Patent Application No. 100 46 908. The individual operator control elements are implemented by pushbutton keys and rotary knobs.

The distraction of the driver from observing the road traffic can be reduced further by not only displaying information on the display but also additionally providing information by the operator control device itself.

German Published Patent Application No. 44 43 912 describes, for the operator control of functions in a motor vehicle, a flat operator control panel which is divided into pushbutton keys, each of which is assigned a switching contact. The selection facilities or functions which are assigned to the pushbutton keys are freely programmable. The respectively current selection possibilities or functions are displayed separately from the operator control panel on a display in the field of vision of the driver, corresponding to the arrangement of the pushbutton keys. The keypad is provided with a touch-sensitive layer, permitting the position of a finger on the operator control panel to be detected. As a result, the area which corresponds to the touched pushbutton key on the operator control panel is highlighted visually on the display. Furthermore, the pushbutton keys of the operator control panel are delimited from one another in a perceptible fashion by salient boundary lines in order to facilitate blind orientation.

German Published Patent Application No. 197 31 285 describes various operator control elements which signal to the user the available operator control or input alternatives by a surface which can be sensed in a tactile fashion. A surface of the operator control element which can be sensed in a tactile fashion makes it possible to indicate clearly to the user which operator control alternative is currently valid or with which operation he can make a selection from various menu items. The operator control surface is divided into an unmoving part and into raiseable or extendable segments which are led into it. In the case of a flat arrangement of the operator control element, raised segments signal the presence of selection alternatives, and in the case of a rotary arrangement of the operator control element, folded-out segments signal the operator control alternative of “rotation” and the countersunk segments signal the operator control alternative of “pressing”.

However, the field of use of the described operator control elements for the motor vehicle is restricted to selection and control functions. Complex operator control processes, such as, for example, searching through a telephone list for a specific entry or inputting a destination address for a destination routing system can, however, be carried out most easily by handwritten character inputs. It is often already sufficient to input a small number of characters in order to produce a large number of alternatives to a selection which can be represented. This method of limiting a large number of alternatives is useful in particular in cases in which the writing keyboard is not available, or else situations in which using such a keyboard constitutes an excessively complex task even if the keyboard were to be simulated on a touch screen. This also relates to the operator control situation in the vehicle.

However, using a touchpad or else a touchscreen, such as are used for handwritten inputs, for selection operations which are to be carried out blind while driving is disadvantage because the smooth surface can be sensed in a tactile fashion only to a poor degree. Even if such a touchpad, such as is described, for example, in PCT International Published Patent Application No. WO 01/54109, can provide information about functionalities or operator control states such that the information can be felt by the user through pulses or vibrations in the surface which are different in certain areas, this still does not permit any reliable blind operator control while driving: haptic information which is based on vibrations easily has vibrations of the vehicle superimposed on it in the driving mode and as a result under certain circumstances increased attentiveness is necessary to detect these vibrations satisfactorily so that feedback of this type is not sufficient for reliable and convenient operator control.

### SUMMARY

An example embodiment of the present invention may provide an operator control device which may permit both selecting inputs and the inputting of handwritten characters for the purpose of controlling systems in a vehicle, and which may be reliably operated in the driving mode.

The operator control device for controlling systems in a motor vehicle may include a touch-sensitive operator control panel on which a user may select inputs from a selection of menu items which correspond to particular zones on the touch-sensitive operator control panel, or on which he may make hand-written inputs in a different operating state of the operator control panel. The operator control panel may be configured such that its surface may, on the one hand, be structured such that it may be sensed in a tactile fashion for the selection of menu items, and on the other hand, the surface may be smoothed such that the operator control panel may also be used for handwritten inputs despite the possibility of structuring it.

For all application cases in which the operator control of systems in a motor vehicle or its functions is to be carried out by a graphic or handwritten input, the surface of the operator control device is operated in a planar state. In order to control the functions by selection operations, the surface is contoured in a manner which may be sensed in a tactile fashion. The operator control panel may therefore be configured in a plastic or flat fashion irrespective of whether the selection of menu items or handwritten inputs is more favorable for the operator control of a function. In this context, the selectable zones of the structured surface may be varied, depending on the operator control process, in extent, shape and position, so that the structure which may be sensed in a tactile fashion may be adapted to the requirements of the respective operator control situation. This means, for example, that only the required number of selectable zones are represented in a plastic fashion, and that the individual zones which may be structured in a manner which may be sensed may be localized in an ergonomically favorable fashion according to the available space and may be represented with different sizes of extent or shape.

The regions of the operator control panel which become selectable zones for a specific operator control process are structured in a manner which may be sensed in a tactile fashion by an actuator system. In order to be able to generate selectable zones, which are different in shape, extent and position, the actuator system which is structured as individual elements may be used. The elements of the actuator system are, depending on the desired embodiment of the operator control panel, capable of being actuated in different groupings or at different locations of the operator control panel, as a result of which the division of the surface of the operator control panel which may be structured in a fashion which may be sensed is implemented in a variable fashion. The degree of variability in the division of the surface is dependent on the structure and the delicate nature of the elements which implement the actuator system. Given a correspondingly suitable arrangement and division of these elements, it is possible to generate a large number of different divisions by combinations of only a small number of actuator elements.

If the functional assignment of the touch-sensitive operator control panel is freely programmable, selectable zones with the desired functionalities may be allocated to the areas which have been structured in a manner which may be sensed in a tactile fashion on the operator control panel, being, for example, adapted to the shape and position of the areas. The functional assignment may therefore always be adapted to the division of the operator control surface into areas which may be sensed in a tactile fashion. In this manner, for the different requirements of various operator control processes, it is possible for both the areas which may be sensed in a tactile fashion and the selectable zones which are congruent therewith to be distributed and configured in terms of position and extent according to ergonomic criteria on the operator control panel, permitting an easy-to-understand and reliable method of operator control.

If, for example, only two alternatives are available for selection in an operator control situation, whether the navigation system or the telephone is to be subsequently operated, for example, two selectable zones which are separated from one another in a manner which may be sensed are presented on the operator control surface. Depending on how many alternative input possibilities require an operator control situation, the selectable zones or the areas which may be sensed in a tactile fashion may be larger or smaller. Thus, for example, in one case the operator control panel may be divided into relatively small “telephone pushbutton keys”, while in another case four relatively large pushbutton keys for direction inputs may be represented.

For handwritten inputs, it may be provided that the entire user surface of the operator control panel is available without subdivisions for inputting characters since handwritten operator control of the device by the user is to be carried out in an uncomplicated manner—simply with a finger—without the aid of a stylus. When characters are input with a finger, more space is required for writing than when inputs are made with a stylus, and the recognition reliability of a character recognition program which is associated with the operator control panel is also increased if the writing may be as large as possible. If the entire operator control panel is available for the inputs, the user may not need to pay particular attention to compliance with certain limits for the handwritten inputs, so that the user may not need to continuously look at the operator control panel when operating it.

A manner of implementing the operator control panel is to configure the operator control panel as a perforation matrix whose holes are filled with plungers which may be raised and lowered again by an actuator system, located under the operator control panel, with an electromechanical device. The plungers may be controlled, for example, individually or in groups.

The sensor system for implementing the touch-sensitivity of the operator control panel may be implemented in the plungers or in the perforation matrix. For example, a capacitive or resistive sensor system is possible for the perforation matrix. If the selectable zones are formed as areas with raised plungers, a capacitive sensor system may be more favorable owing to the distance between a finger and the surface of the perforation matrix. If, on the other hand, the selectable zones are formed as countersunk areas—between areas with raised plungers—the sensor system may be implemented in a capacitive or resistive fashion.

If the touch-sensitivity of the operator control panel is to be implemented by the plungers, they may be equipped, for example, with a capacitive sensor system. In an example embodiment of the plungers made of optical waveguide material, the finger position may also be detected by detecting reflections or shadowing. If the selectable zones are represented areas with raised plungers, a pressure-sensitive sensor system may also be used to detect the finger position.

If the operator control panel is used to detect handwriting, all the plungers are lowered in the perforation matrix so that the operator control panel has an essentially planar and smooth surface. The recognition of the characters which are input by following the finger position may be carried out by a sensor system in the perforation matrix or a sensor system in the plungers.

An example embodiment of the plungers may be manufactured from light-guiding material and may be illuminated by a light source underneath the actuator system since in this manner the respective structuring of the operator control panel may be visually underlined by the illumination, and the operator control device may thus be easily located even at night.

An example embodiment of the operator control device may provide that the surface of the operator control panel is arranged as a touch-sensitive film which is undetachably connected to a planar, fixed underlying surface at the edge of the operatator control panel, and the space between the underlying surface and film is filled with a rheological fluid which may be solidified and fluidized again by an actuator system. Rheological fluids are characterized by the fact that their viscosity may be controlled. The viscosity of electro-rheological fluids is influenced by electrical fields, and that of magneto-rheological fluids is influenced by magnetic fields.

The touch-sensitive sensor system may be integrated into the film which is at the top on the operator control panel since the film is directly in contact with the touching finger, as a result of which the greatest possible degree of proximity to the sensor system may be achieved. This sensor system may be implemented in a capacitive or resistive fashion, in which case a resistive sensor system may also be operated with gloves.

The structuring of the operator control panel may be achieved by hardening the rheological fluid in accordance with the respective configuration and activation of the elements of the actuator system. Since the fluid in the region between the film and fixed underlying surface does not predefine a structure for the conditioning of a surface which may be sensed, the areas in which the fluid is to be solidified are determined solely as a function of the structuring and flexibility of the elements of the actuator system.

The areas with solidified fluid may be sensed by touch through the film resting on the fluid in comparison with the areas with non-solidified fluid since they may be sensed as a thickened portion compared to the areas which are not solidified and in the areas which are not solidified the fluid may be expelled by the probing finger. In this context, the selectable zones may be respectively represented by the solidified or the fluidized areas. The surface structure may be completely disintegrated by deactivating the actuator system so that a finger or stylus may easily expel the fluid and the film is pressed directly onto the planar, fixed underlying surface. In this form, the operator control panel provides the possibility of making handwritten inputs on the touch-sensitive film.

An electro-rheological fluid may be used as a Theological fluid. The solidification of the fluid is brought about by electrical fields which may be generated by an actuator system. The actuator system may include, for example, electrode pairs which are opposite one another on the underside of the touch-sensitive film and on the surface of the solid, planar surface under the film. The electrodes may, for example, be pressed onto the respective surface, ensuring the largest possible degree of evenness of the operator control panel.

A magneto-rheological fluid may also be used as Theological fluid. The solidification of the fluid is brought about by magnetic fields which may be generated by a corresponding actuator system. The actuator system elements may include, for example, magnets which are located under the operator control panel and which are moved closer to the operator control panel from below—and thus to the magneto-rheological fluid—in order to generate magnetic fields which act on the magneto-rheological fluid. In order to cancel the magnetic field, the magnets are moved again to a suitable distance from the magneto-rheological fluid. In this context, the magnetic may also be generated by rotatably mounted magnets, by tilting through 90 degrees, or sufficiently weakened again, with the axis of rotation arranged perpendicular to the field lines of the magnets. In addition, there is the possibility of shielding the magnets from the magneto-rheological fluid on the actuator path by a film or a piece of sheet metal.

For the reliable operation of the operator control device, the operator control device may be accommodated in an area which is directly within reach of the driver, as the primary user of the device. For the visual orientation of the user by the functional assignment of the operator control panel, it may be provided that the selectable menu items are displayed in the field of vision of the driver. This may be implemented by a display device which is separated from the operator control device and is located in the field of vision of the user. In this manner, the driver may be distracted least by the road traffic when operating the systems by the operator control device while driving.

The selectable menu items, such as correspond to the functional assignment of the zones which may be selected on the operator control panel, may be arranged on the display device in a manner which corresponds to the arrangement of the menu items on the operator control panel. Information for user prompting is additionally represented on the display device in order to provide user-friendly support for the systems and functions which may be operated by the operator control device.

One manner of accommodating the operator control device is to install it in the armrest between the driver's seat and front passenger's seat where it may be accommodated such that it may be extended or folded out. In the ready-to-operate state, the user surface is then located horizontally oriented in front of the armrest, somewhat below the level of the armrest, so that it may be comfortably operated with a freely movable hand which is relieved of loading and stabilized by the arm resting on the armrest. However, other installation locations, for example, in the center console, are also possible.

The display device may be accommodated in the dashboard or in the console.

A menu item is selected on touch-sensitive operator control panels by a finger or some other object coming into contact with the corresponding selectable zone of the touch-sensitive operator control surface. In order to visually orientate the user, the respective contact zone on the display device is usually represented contrasted by color, inverted or visually highlighted in some other manner with respect to the other selectable menu items.

In order to confirm a selection by the user which is made from the functional assignment of the operator control panel in order to represent an Enter function, it may be provided that the operator control panel is mounted on a pressure-sensitive sensor system. In this manner, the operator control panel may function as it were as a large pushbutton key. By pressing a finger on the operator control panel and subsequently releasing it, the contacted menu item is selected as valid. Other functions, for example, a switchover function, may also be realized by an operator control panel which is mounted on an appropriately pressure-sensitive sensor system.

The valid triggering of a function which is activated by a pressure on the operator control panel may be communicated to the user in a manner which may be sensed in a tactile fashion by haptic feedback such as may be realized by switching elements with a pressure point to be overcome by pressure. In this manner, reliable detection of the function triggering is possible even when there are unavoidable vibrations in the traveling vehicle.

The operator control panel may be surrounded by a housing so that the position and dimensions of the operator control panel may be directly sensed by touch by the surrounding frame which forms the housing.

What is referred to as an Escape function for aborting a function, for deleting an input or jumping back to a superordinate menu may be provided for an uncomplicated operator control of hierarchically organized menu functions. In this context, for reasons of rapid and reliable access, it may be provided that such special functions are not implemented on the actual operator control panel—as a selectable menu item—but rather separately from it in the surface of the housing as pushbutton keys which are stepped in a manner which may be sensed with a fixed local relationship. Such deletion and jumpback functions and possibly further special functions may be realized by various fixed pushbutton keys at different locations in the housing or by various operator control modes of a pushbutton key. The jumpback level may be defined, for example, by repeated activation of a pushbutton key, and a direct jumpback into the main menu may be carried out, for example, by a relatively long application of pressure to this pushbutton key.

Example embodiments of the present invention described in more detail below with reference to the appended Figures.

### BRIEF DESCRIPTION OF THE DRAWINGS

FIG. 1 illustrates an operator control device according to an example embodiment of the present invention, represented with a smoothed surface for handwriting inputs.

FIG. 2 illustrates a user prompting system for controlling a navigation system by handwritten inputs on a display device.

FIG. 3 illustrates the sensor system of a touch-sensitive operator control panel with bores for the plungers.

FIG. 4 illustrates an example of an actuator system for raising the plungers from the surface of the operator control panel.

FIG. 5 illustrates an operator control device according to an example embodiment of the present invention, represented with a structured surface for selecting menu items.

FIG. 6 illustrates the functional assignment of the operator control panel illustrated in FIG. 5 on a display device with additional information for user prompting.

FIGS. 7a and 7b are cross-sectional views through the operator control panel of an operator control device such as is illustrated in FIG. 5, with an electrical actuator system with a smoothed surface and with a structured surface.

FIG. 8 is a cross-sectional view through the operator control panel of an operator control device such as is illustrated in FIG. 5, with a magnetic actuator system and partially structured surface.

FIGS. 9a, 9b and 9c illustrate various possible manners of structuring the surface of the operator control panel of the operator control device.

### DETAILED DESCRIPTION

The references are in particular as follows:
1 a first embodiment of the operator control device,
2 an operator control panel in the form of a perforation matrix,
3 a housing,
4 plunger,
5 a pushbutton key,
6 a handwritten input,
7 bores in a touch-sensitive operator control panel, 8 electrodes of the sensor system,
9 isolated areas of the sensor system,
10 mount for plunger,
11 a second embodiment of the operator control device,
12 an operator control panel with a touch-sensitive film,
13 a slide,
14 selectable zones,
15 a fixed, planar surface,
16 electrodes,
17 magnets,
18 electro-rheological fluid, in fluid form,
19 electro-rheological fluid, in solid form,
20 sensor film,
21 magneto-rheological fluid, in fluid form,
22 magneto-rheological fluid, in solid form,
25 an operator control panel,
26 selectable zones for direction data,
27 selectable zones for telephone operator control, 28 a handwritten input,
29 lifting elements,
30 a display device,
31 a list,
32 and 33 input boxes,
34 display of an assignment of the operator control device with the functions of a telephone keypad

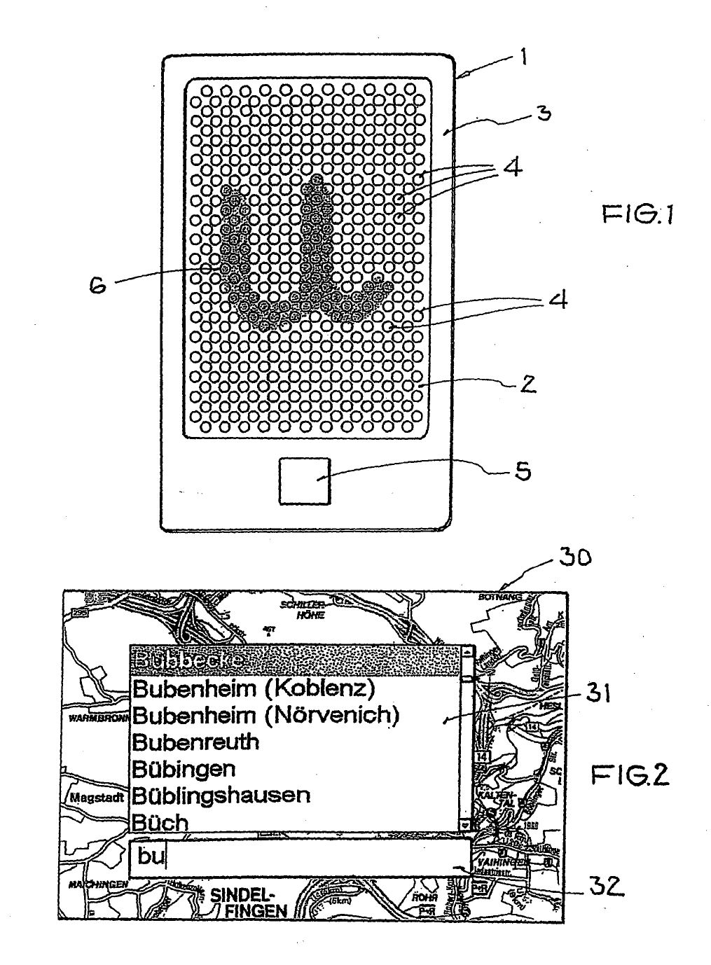

FIG. 1 illustrates an operator control device 1 according to an example embodiment of the present invention as a perforation matrix with plungers in the state with a soothed surface such as may be used for handwritten inputs.

FIG. 2 is an exemplary illustration of the possible user prompting system on a display device 30, for example on an LCD display, for controlling a navigation system by handwritten inputs on the operator control device 1 illustrated in FIG. 1. The freely selectable inputting of handwritten characters allows lists with extensive selection possibilities such as, for example, destination data for a navigation system, to be efficiently limited. The recognition result of the handwritten input 6 which is made on the operator control panel 2 is displayed to the user in the input box 32. Incorrect inputs may be erased by the user by, for example, simply inputting a transverse line from right to left on the operator control panel.

If a selection is limited by handwritten inputs to the extent that the remaining selection possibilities may be selected by scrolling, i.e., with incremental upward or downward movements of the mark in the list 31, the input possibility on the operator control panel 2 may be switched over to this operator control mode automatically by controlling the operator control sequence or manually by the user. When there is a pressure-sensitive sensor system of the operator control panel, this may be brought about by the user by, for example, briefly pressing twice on the operator control panel.

The character recognition mode for the outlined use of the operator control device 1 is then ended and the operator control panel 2 is switched over, for example, into a selection mode for scrolling through a list.

For this purpose, for example, three areas which may be sensed in a tactile fashion are presented in a vertical arrangement on the operator control panel 2 by raising plungers, the functionalities “move mark upward”, “select the marked position” and “move mark downward” corresponding, as selectable zones, to the areas. In this case, for example, the selectable zone with the function “move mark upward” may be shaped by the plungers as a triangle with the tip upward, and the selectable zone with the function “move mark downward” may be shaped as a triangle with the tip downward; and the function “selection of the marked position” may be given a round shape for the purpose of better tactile differentiation for the two other functions.

Touching and pressing down the upper selectable zone causes the mark in the list 31 to be moved one position upward, with the list 31 being updated, if appropriate, with inputs which have been invisible. Touching and pressing down the lower zone of the operator control panel causes the mark to be correspondingly moved downward. A marked position is, for example, selected in a valid fashion by touching the central zone of the operator control panel 2 and pressing it down. For the illustrated example this means that the selected town is transferred into the input box 32 as a destination for the navigation system.

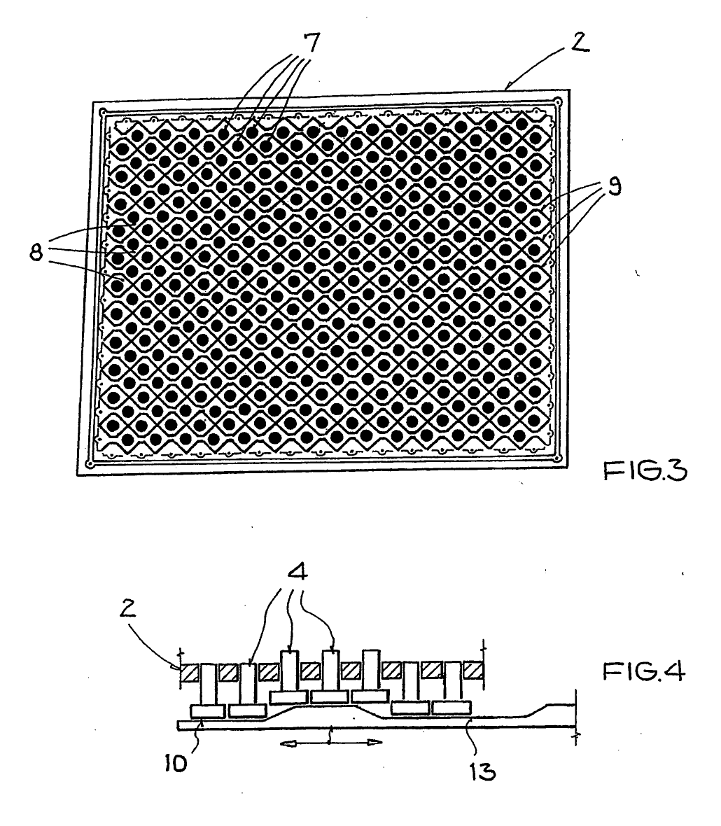

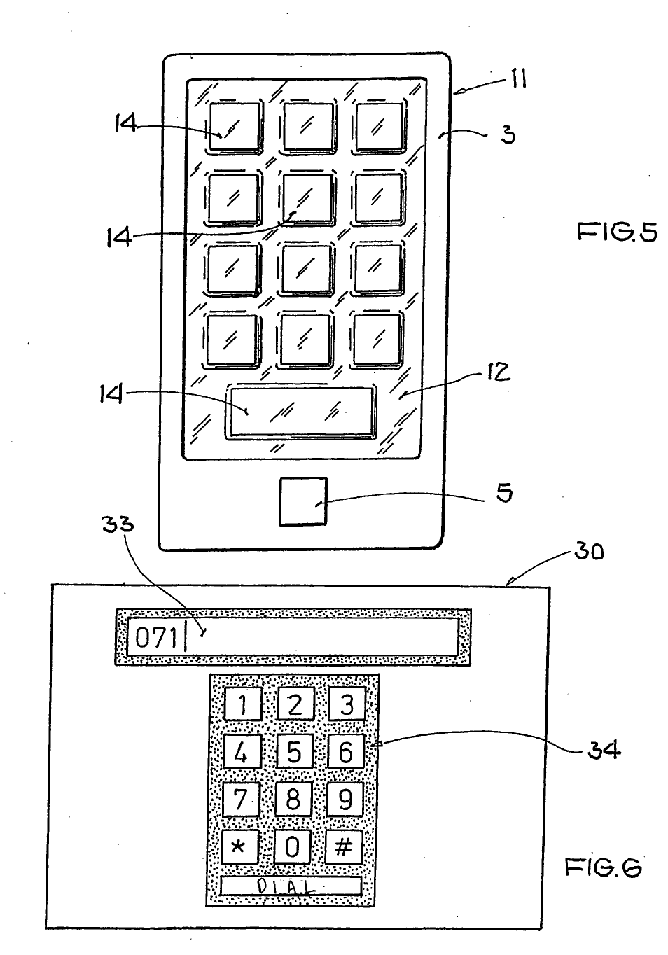

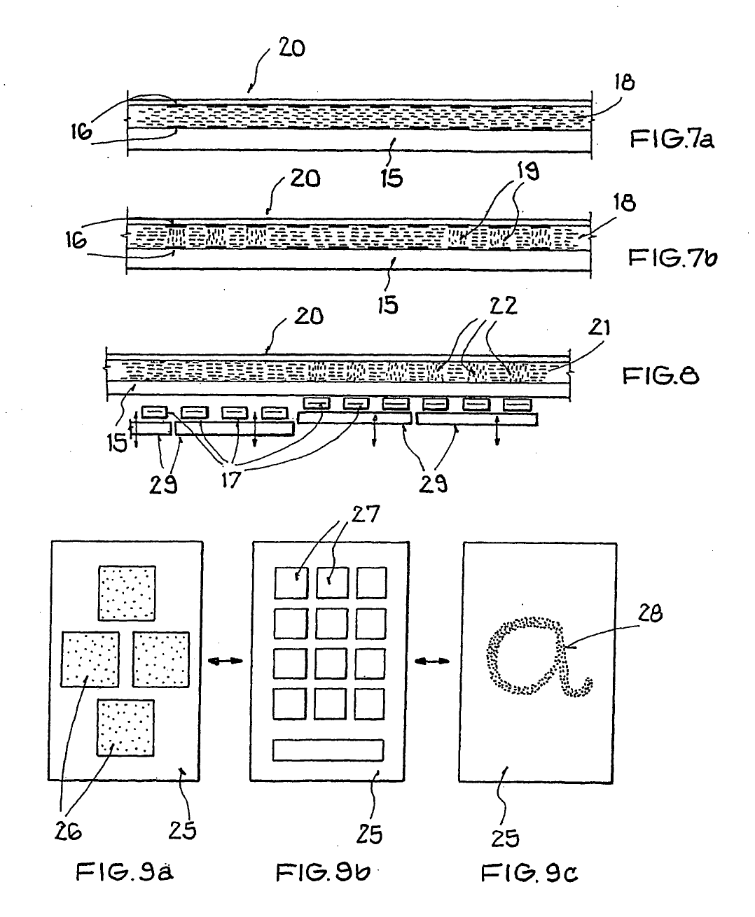

FIG. 3 illustrates the underside of a touch-sensitive operator control panel 2 which is reconfigured to form a perforation matrix, with the electrode array of the sensor system and the bores for the plungers.

The bores in operator control panel are located centrally in the electrodes of the capacitive sensor system so that interruptions are not produced in the conductive layer. (The electrodes of the illustrated capacitive sensor system on the operator control panel 2 are designated by 8; isolated areas are designated by 9.) The sensor functions of the touch-sensitive operator control panel 2 for determining position and for inputting characters may thus be readily ensured despite the bores 7.

FIG. 4 illustrates an example of an actuator system for raising the plungers 4 out of the surface of the operator control panel 2. The plungers 4 are raised successively by a slide 13. Depending on the width of a slide 13, only a single row of plungers is moved by the slide, or a plurality of slides are moved simultaneously by plungers. The slide 13 may be shaped such that it firstly raises a number of plungers in the pushing direction and allows them to drop again further to the rear. A plurality of patterns which may be sensed in tactile fashion may be generated on the operator control panel by various arrangements of such slides, which may be pushed, for example, under the operator control surface from all four sides, and by slides which are shaped in the same manner or differently and by inserting the slides to different degrees under the operator control panel.

For a simplified actuator system, the plungers may be combined on mounts 10 to form groups with a plurality of plungers. However, it is also possible to raise the plungers individually or in groups by lifting devices instead of by slides, and to generate different patterns, which be sensed in a tactile fashion, on the operator control panel by appropriately structuring the lifting devices.

FIG. 5 illustrates an operator control device 11 according to an example embodiment of the present invention, in the state with a structured surface which is arranged in a manner which may be sensed in a tactile fashion. The arrangement of the surface is brought about by a rheological fluid which is located between a planar, solid underlying surface and a touch-sensitive film lying on it, the latter being fixedly connected to this underlying surface at the edge of the surface. The selectable zones 14 or “pushbutton keys” are characterized by a solidification, which may be sensed, in an otherwise gallery-like mass, which may easily be expelled by a finger, under the smooth surface of the film. The solidification is brought about by a change in viscosity of the Theological fluids.

Rheological fluids include an emulsion of oils and polarizable particles which orientate themselves under the influence of electrical or magnetic fields and thus influence the flow properties of the emulsion. The rheological fluid is moved into the areas of the selectable zones 14—representing a telephone keypad by a corresponding actuator system under the influence of electrical or magnetic fields. The fluids are stable in terms of sedimentation of the polarizing particles the application temperature range in a motor vehicle.

Each selectable zone 14 on the operator control panel 12 corresponds to a selectable menu item or a functionality. Different functionalities of the operator control panel which may be structured in a manner which may be sensed in a tactile fashion may therefore each be configured as a menu structure. In the exemplary application illustrated, the functionalities of a telephone keypad are assigned to the selectable zones. The “pushbutton keys” are located such that they may be sensed by touch between the functionless areas in which the Theological fluid may be expelled by a finger because there are no electrical or magnetic fields acting there. However, the areas which support functions may be represented surrounded or delimited by solidified areas as well as by nonsolidified areas.

In a resistive sensor system of the touch-sensitive operator control surface, both the sensing of a pushbutton key and functional triggering or confirmation of an input may be implemented, for example, by various pressure threshold values. With a sensor system which is based on the change in resistance, there may be the advantage compared to a capacitive method that contact with gloves may also be detected without difficulty.

Functional triggering may also be carried out by electromagnetic switches, with a pressure on the operator control panel which is necessary to trigger a function being kept greater than the pressure for sensing the solidified areas. For this purpose, the operator control panel 2 is mounted, for example, on a plurality of pressure-sensitive electromechanical switching elements, optionally on just one such element with additional suitable guides for the operator control panel, so that a pressure point over the entire surface may be implemented for the operator control panel 2. By pressing on the operator control panel 2 which is mounted in a pressure-sensitive manner, it is possible not only to trigger functions or confirm inputs but, depending on the operator control situation, it is possible, for example, by pressing down the entire operator control panel too, also to trigger the switching over of the operator control mode from, for example, handwritten input into a Scroll mode (as described with respect to FIG. 2).

If the operator control device 11 is used for selectable inputs, a position recognition device is used to determine in which zone, for example, a user's finger is located. So that reliable differentiation between the various selectable zones is possible when the operator control panel is operated with a finger, the areas which support meaning or functions may also be separated from one another by intermediate areas without meaning—a mute circuit.

The geometric arrangement of selectable zones 14—illustrated in FIG. 5—on the operator control panel 12 is to be understood only as exemplary; the selectable zones may also assume other forms, like in the exemplary embodiment illustrated in FIG. 1, depending on the structuring and/or mobility of the actuator system, so that various functionalities may be represented in an appropriate manner on the operator control panel.

The pushbutton key 5 in the housing 3 of the example embodiments 1 and 11 of the operator control devices is used, in terms of hierarchically organized operator control menus, to represent special functions such as, for example, to implement an Escape function for jumping back rapidly from lower operator control menu levels into higher operator control menu levels or for deleting the input which has been respectively made last.

Various implementations are possible for the implementation of delete or Escape functions: briefly pressing the Escape key 5 once may, depending on the particular current operator control mode, bring about the deletion of the last input or, when the input box is empty or not present, return the system to the initial control state of the system which is currently selected for operator control. Actuation of the Escape key 5 three times briefly in succession or once for a long time may be implemented, for example, as a manner of aborting the operator control of the respective function and returning to the start menu or main menu. However, in order to implement various special functions such as, for example, a jump back into a superordinate menu or deletion of the last input, it is also possible to provide a plurality of pushbutton keys in the housing.

In the housing 3 of the operator control devices 1 and 11, it is also possible to accommodate the following arrangement for operating the operator control device under the operator control panel next to the electronics which are associated with the operator control panel and have the purpose of sensing a finger position: the actuator system for reconfiguring the surface shape, the switching elements for implementing the pressure point of the operator control panel and connections to an electronic control system with which the operator control device and the functions of the operator control panel are controlled.

FIG. 6 illustrates the representation of the functional assignment of the operator control panel 12 illustrated in FIG. 5 on a display device 30 with additional information for user prompting, for orientating the user about the arrangement and significance of the individual, selectable menu items—for example, the functionality of a telephone keypad—as well as further information for menu prompting, for example, an input box 33 for orientating the user about the inputs which have been made.

For the purpose of optimum user prompting, the functional assignment of the operator control panel 34 which is valid for an operator control situation is represented on the display device in a manner which corresponds to the arrangement of the selectable zones on the operator control panel. If the position detection device detects a finger contact in the region of a selectable zone, the area on the display corresponding to this zone is highlighted visually in its visual representation in comparison with the other illustrated selection possibilities. The input box 33 gives the user an overview of inputs which have already been made.

FIGS. 7a and 7b are cross-sectional views through the operator control panel illustrated in FIG. 5 in the flat state with an electro-rheological fluid in a reservoir underneath the touch-sensitive film 20 which is formed for detecting the finger position, with an actuator system which includes electrode pairs 16. The electrodes may be implemented, for example, as printed circuits on the film 20 and the solid, planar surface 15. FIG. 7a illustrates the fluid without the influence of a voltage which is applied to the electrode pairs 16 in the completely fluid state 18. In this state, handwritten characters may be recognized on the touch-sensitive film 20. The writing finger may then effortlessly expel the fluid. The position detection device on the touch-sensitive film is not influenced by this.

FIG. 7b illustrates a number of electrode pairs 16 with a voltage applied, as a result of which the fluid in the areas 19 is solidified so that it may be sensed by a finger which slides over the film 20. The electrode pairs 16 may be actuated individually, allowing areas of the surface of the operator control panel which have various sizes and various shapes to be sensed and thus made into selectable zones as a function of the modular dimensions of the electrodes.

FIG. 8 is a cross-sectional view through the operator control panel illustrated in FIG. 5 in a flat state with a magneto-rheological fluid in a reservoir underneath the touch-sensitive film 20, formed for detecting the finger position, with an actuator system which includes magnets 17. The magnets may be moved close to the underside of the solid, planar surface 15 by lifting elements 29 to such an extent that the field strength of the respective magnetic field on the magneto-rheological fluid above the surface 13 is sufficient to the solidify the fluid. The positioning may be carried out, as illustrated in FIG. 8, by movement in the direction of the fluid layer or by rotating the magnets through 90°, as a result of which the field lines extend parallel or perpendicular to the layer, or else by a screen of the field lines by suitable materials. Depending on the number, size and possibility of actuating the magnets, it is possible to sense areas of the surface of the operator control panel which have different shapes, thus permitting them to be made into selectable zones.

The magnetic fields for solidifying the magneto-rheological fluid may also be generated by coils. However, the use of magnets may provide that after appropriate positioning there is no need for any further power drain for the operating state with the solidified fluid.

In FIGS. 9a, 9b and 9c various possible manners of structuring the surface of the operator control panel 25 of the operator control device are illustrated. FIG. 9a illustrates the operator control panel 25 with four selectable zones 26 which may serve, for example, to control a cursor, illustrated on the display device 30, in the upward, downward, left-hand and right-hand directions, or to selector input directions. In FIG. 9b, the operator control panel 25 is reconfigured for the operator control of, for example, a telephone keypad with a corresponding arrangement of selectable zones 27. In FIG. 9c, the operator control panel 25 is illustrated with the leveled-out operator control surface for inputting handwritten characters 28.

1-12. (canceled)

13. An operator control device for controlling systems in a motor vehicle by inputs by a user, comprising:
a touch-sensitive operator control panel adapted to represent two surface shapes alternately changeable into one another, a first surface shape structured to be sensible in a tactile manner and usable to select zones on the operator control panel to select menu items, individual selectable zones configurable differently in shape, extent and position on the operator control panel, a second surface shape smooth in comparison with the first surface shape, the second surface shape adapted for hand-written and graphic input.

14. The device according to claim 13, further comprising an actuator system adapted to configure at least one of (a) the shape and (b) the extent of the selectable zones as individual elements, a division of the touch-sensitive operator control panel into the selectable zones and functional assignment of the selectable zone freely programmable, an entire touch-sensitive operator control panel adapted for hand-written input.

15. The device according to claim 14, wherein the touch-sensitive operator control panel is arranged as a perforation matrix having holes provided with plungers, the plungers electromechanically raisable and lowerable by the actuator system located underneath the operator control panel.

16. The device according to claim 15, wherein the plungers are formed of a light-guiding material and are illuminatable by a light source arranged underneath the operator control panel.

17. The device according to claim 14, wherein a surface of the touch-sensitive operator control panel is arranged as a touch-sensitive film undetachably connected to a planar, fixed underlying surface at an edge of the operator control panel, a space between the underlying surface and the film filled with a Theological fluid solidifyable and fluidizable by the actuator system.

18. The device according to claim 17, wherein the rheological fluid is an electro-rheological fluid, the actuator system adapted to generate electrical fields.

19. The device according to claim 17, wherein the rheological fluid is a magneto-rheological fluid, the actuator system adapted to generate magnetic fields.

20. The device according to claim 13, wherein the operator control device is arranged in directly accessible surroundings of the user, a separate display device for user prompting for operating systems operable by the operator control device arranged in a direct field of vision of the user.

21. The device according to claim 13, wherein the operator control panel is mounted on a pressure-sensitive sensor system.

22. The device according to claim 21, wherein operator control panel is adapted to provide the user with feedback that is sensible in a tactile manner when a pressure point of the pressure-sensitive sensor system is exceeded by pressing on the operator control panel.

23. The device according to claim 13, wherein the operator control panel is surrounded by a housing that is sensible in a tactile manner.

24. The device according to claim 23, wherein the housing includes at least one pushbutton key for special functions.
